(19) United States
(12) Patent Application Publication
(10) Pub. No.: US 2013/0253891 A1
(43) Pub. Date: Sep. 26, 2013

(54) SIMULATION DEVICE, SIMULATION PROGRAM AND BINOCULAR VISION EXPERIENCING METHOD

(71) Applicant: HOYA CORPORATION, Tokyo (JP)

(72) Inventors: Satoshi INOUE, Tokyo (JP); Eijiroh TADA, Tokyo (JP); Fumitaka SUTO, Tokyo (JP)

(73) Assignee: HOYA CORPORATION, Tokyo (JP)

(21) Appl. No.: 13/849,119

(22) Filed: Mar. 22, 2013

(30) Foreign Application Priority Data
Mar. 22, 2012 (JP) 2012-065669

(51) Int. Cl. G06F 17/50

(52) U.S. Cl. CPC G06F 17/5009
USPC 703/6

(57) ABSTRACT

A simulation is configured including: an image generation part configured to generate mutually different two images as an image which is viewed by right and left eyes respectively through a lens in a monovision prescription state, when a relation between a point spread function and a distance is set in a different state by wearing the lens in the monovision prescription state; and an image displayer configured to display the two different images generated by the image generation part individually for each of the right and left eyes of an examinee.

### BACKGROUND

1. Technical Field

The present invention relates to a simulation device, a simulation program and a binocular vision experiencing method that provide a virtual experience of a view through a binocular vision in a monovision prescription state.

2. Description of Related Art

Generally, in a case of myopia and presbyopia, a visual acuity is corrected using a spectacle lens or a contact lens. Particularly, in a case of the presbyopia, the visual acuity is sometimes corrected using a progressive refractive lens for example. Further, in an ophthalmic treatment spot, treatment using an intraocular lens (IOL) is performed to cataract patients for example.

When such a lens is used, lens users don't know the view until the lens is actually worn by them. Particularly, it is difficult to grasp a virtual view in a case of the progressive refractive lens, because the view is influenced by a distortion aberration, etc. Therefore, patent document 1 proposes a technique of creating and displaying a retinal image by simulation for a user of spectacles using a progressive refractive lens for example, which is viewed when the progressive refractive lens is worn, to thereby provide a virtual experience of a view through the spectacles (for example see patent document 1).

Meanwhile, not the progressive refractive lens but a technique called a monovision is sometimes used to cope with an adjusting power disorder due to presbyopia. The “monovision” is a technique of wearing a lens focused for near viewing on one of the eyes, and wearing a lens focused for distant viewing on the other eye, so that a dominant eye is corrected so as to be suitable for the far vision, and a non-dominant eye is corrected so as to be suitable for the near vision, and role-sharing is achieved by right and left eyes for the far vision and the near vision (for example see patent document 2). Such a monovision is usually applied to a case that a contact lens or an intraocular lens (IOL) is used, thereby responding to both case of the far vision and near vision not through the spectacles.

### Patent Document 1:

International Patent Publication No. 2010/044383

### Patent Document 2:

Japanese Patent Laid Open Publication No. 1992-227258

Incidentally, the view in the monovision prescription state is an uneven view called anisometropia in which visual acuities of the right and left eyes are largely different. However, there are individual differences in resistance to the anisometropia. Therefore, a user of a lens prescribed based on the monovision sometimes feels uncomfortable through the binocular vision. More specifically, there is the role-sharing in the monovision prescription state, by the right and left eyes for the far vision and the near vision. Therefore, a far vision image and a near vision image are not identical through the binocular, vision, and as a result, flickering is felt in some cases. Accordingly, prior to the monovision prescription, it is extremely important to provide a virtual experience of the view, which is the view through the binocular vision, to users of the lens prescribed in the monovision state, and confirm whether they feel uncomfortable when wearing this lens.

However, conventionally, the uncomfortable feeling through the binocular vision can not be verified in the monovision prescription state. This is because an exact state of anisometropia is required for verifying the uncomfortable feeling in the monovision prescription state, and meanwhile in a conventional simulation technique disclosed in the patent document 1 for example, a state after correcting the visual acuity, namely an isometropic state of the right and left eyes is estimated. Namely, the conventional simulation technique does not estimate a case that the anisometropic state is forcibly created, so that a different image is viewed by the right and left eyes respectively. Therefore, for example even when the conventional simulation technique is used, the uncomfortable feeling through the binocular vision cannot be verified in the monovision prescription state.

In order to solve a new problem which is not found in the above-mentioned conventional technique, the present invention is provided, and an object of the present invention is to provide a simulation device, a simulation program and a binocular vision experiencing method, capable of verifying the uncomfortable feeling through the binocular vision in the monovision prescription state.

### SUMMARY OF THE INVENTION

In order to achieve the above-described object, inventors of the present invention verify a cause for generating an uncomfortable feeling in the view through a binocular vision in the monovision prescription state. The uncomfortable feeling may be probably generated, because a far vision image and a near vision image are not matched each other through the binocular vision, namely the uncomfortable feeling may be generated due to an anisometropia. Therefore, the inventors of the present invention obtain a concept that the uncomfortable feeling through the binocular vision in the monovision prescription state can be verified by employing an unconventional completely new concept that the anisometropia is created by viewing two mutually different images through the right and left eyes, irrespective of a conventional general concept of a simulation technique such that a retinal image is reproduced after correcting a visual acuity so that the right and left eyes are set in an isometropic state.

The present invention is provided based on the above-mentioned new concept by the inventors of the present invention.

According to a first aspect of the present invention, there is provided a simulation device, including:

an image generation part configured to generate mutually different two images, as each image which is viewed by right and left eyes respectively through a lens in a monovision prescription state, when a relation between a point spread function and a distance is set in a different state by wearing the lens in the monovision prescription state; and

an image displayer configured to display the two different images generated by the image generation part individually for each of the right and left eyes of an examinee.

According to a second aspect of the present invention, there is provided the simulation device of the first aspect, wherein the image generation part is configured to generate an image based on the point spread function in a case of viewing the image through the lens.

According to a third aspect of the present invention, there is provided the simulation device of the first or second aspect, wherein the two images generated by the image generation part are an image for a far vision and an image for a near vision.

According to a fourth aspect of the present invention, there is provided the simulation device of the first, second, or third aspect, wherein the two images generated by the image generation part are an image for a dominant eye and an image for a non-dominant eye.

According to a fifth aspect of the present invention, there is provided the simulation device of any one of the first to fourth aspects, wherein the image generation part generates an image in which a plurality of image elements having different recognition mode parameters, are shown in a list form.

According to a sixth aspect of the present invention, there is provided the simulation device of any one of the first to fifth aspects, wherein the image generation part is configured to generate the two images in consideration of an angle corresponding to a size of each image element and an angle corresponding to an interval between adjacent image elements.

According to a seventh aspect of the present invention, there is provided the simulation device of any one of the first to sixth aspects, wherein the image generation part is configured to generate the image in consideration of a distance from the examinee to a display image displayed by the image displayer.

According to an eighth aspect of the present invention, there is provided the simulation device of the first to seventh aspects, wherein the image generation part is configured to generate the two images in consideration of a converging angle of the right and left eyes corresponding to the distance from the examinee to the display image displayed by the image displayer.

According to a ninth aspect of the present invention, there is provided the simulation device of any one of the first to eighth aspects, which is used in combination with an ophthalmic aberration measurement device for measuring an aberration of an eyeball of the examinee.

According to a tenth aspect of the present invention, there is provided a simulation device configured to display two mutually different images created for verifying an uncomfortable feeling in a view through a binocular vision in a monovision prescription state, for each of the right and left eyes.

According to an eleventh aspect of the present invention, there is provided a simulation program, for making a computer realize a simulation function of displaying a mutually different two images crated for verifying an uncomfortable feeling in a view through a binocular vision in a monovision prescription state, for each of the right and left eyes.

According to a twelfth aspect of the present invention, there is provided a binocular vision experiencing method, wherein mutually different two images created for verifying an uncomfortable feeling in a view through a binocular vision in a monovision prescription state, are displayed for each of the right and left eyes.

According to the present invention, the uncomfortable feeling through the binocular vision in the monovision prescription state, can be verified.

### BRIEF DESCRIPTION OF THE DRAWINGS

FIG. 1 is an explanatory view showing an outline of a monovision prescription, wherein FIG. 1A is a view showing a state before prescription, and FIG. 1B is a view showing a state after prescription using a single focus lens, and FIG. 1C is a view showing a state after prescription using a multifocal lens.

FIG. 2 is a block diagram showing a system constitutional example of a simulation device according to this embodiment.

FIG. 3 is a block diagram showing a function constitutional example in a simulation processor included in the simulation device according to this embodiment.

FIG. 4 is a flowchart showing an example of a procedure of the simulation processing performed by the simulation device according to this embodiment.

FIG. 5 is an explanatory view showing a first example of a result of performing the simulation processing using the simulation device, wherein FIG. 5A is showing the properties of the monovision prescription according to the first example, and FIG. 5B is a view showing a display image according to the first example.

FIG. 6 is an explanatory view showing a second example of a result of performing the simulation processing using the simulation device according to this embodiment, wherein FIG. 6A is showing the properties of the monovision prescription according to the second example, and FIG. 6B is a view showing a display image according to the second example.

FIG. 7 is an explanatory view showing a third example of a result of performing the simulation processing using the simulation device according this embodiment, wherein FIG. 7A is showing the properties of the monovision prescription according to the third example, and FIG. 7B is a view showing a display image according to the third example.

FIG. 8 is an explanatory view showing a fourth example of a result of performing the simulation processing using the simulation device according to this embodiment, wherein FIG. 8A is showing the properties of the monovision prescription according to a fourth example, and FIG. 8B is a view showing a display image according to the fourth example.

FIG. 9 is an explanatory view showing a fifth example of a result of performing the simulation processing using the simulation device according to this embodiment, wherein FIG. 9A is showing the properties of the monovision prescription according to a fifth example, and FIG. 9B is a view showing a display image according to the fifth example.

FIG. 10 is an explanatory view showing a sixth example of a result of performing the simulation processing using the simulation device according to this embodiment, wherein FIG. 10A is showing the properties of the monovision prescription according to the sixth example, and FIG. 10B is a view showing a display image according to the sixth example.

### DETAILED DESCRIPTION OF THE INVENTION

An embodiment of the present invention will be described hereafter, based on the drawings.

In this embodiment, explanation is given by classifying the contents into items in the following order.
1. Monovision
2. System structure
3. Functional structure
4. Simulation procedure
5. Specific example of simulation
6. Effect of this embodiment
7. Modified example, etc.

### 1. MONOVISION

First, prior to the explanation for the simulation device, etc., of this embodiment, monovision as precondition of the simulation device will be simply described.

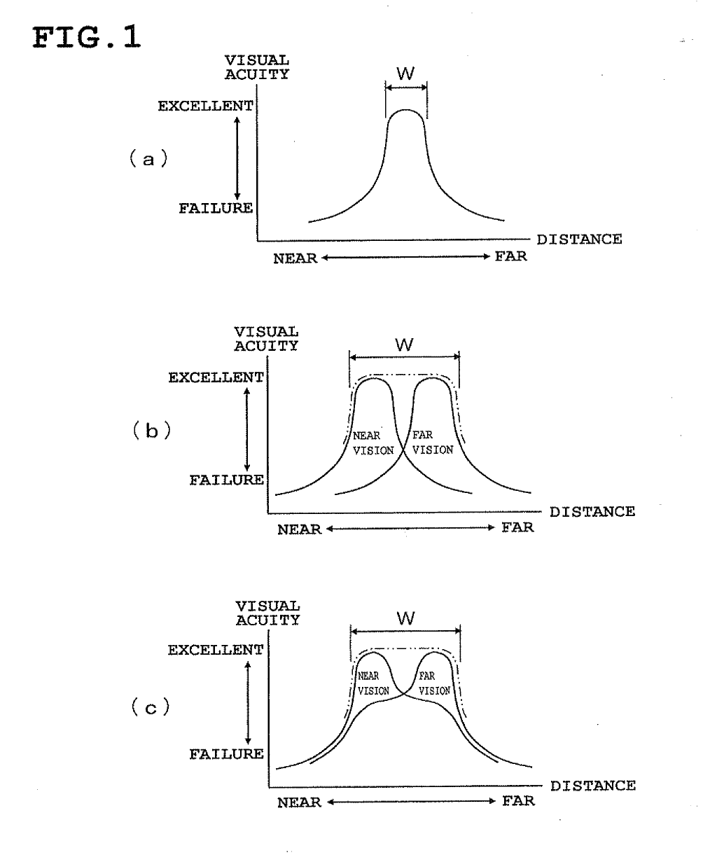

FIG. 1 is an explanatory view showing an outline of the monovision prescription.

The monovision is defined as one of the techniques of a prescription for an adjusting power disorder due to presbyopia, which is a concept of role-sharing of the right and left eyes for a far vision and a near vision by wearing on one of the eyes a lens focused for the near vision, and wearing on the other eye a lens focused for the far vision. Specifically, a generally performed prescription is that, for example, a dominant eye is corrected so as to be suitable for the far vision, and a non-dominant eye is corrected so as to be suitable for the near vision. However, the reversed prescription is also acceptable.

For example, when the adjusting power disorder due to presbyopia is generated, elasticity of a crystalline lens is weakened, and therefore as shown in FIG. 1A, an object in the near vision cannot be focused. Namely, if compared with a normal adjusting power, a width of a distance in which a satisfactory visual acuity can be obtained (see W in the figure), is narrowed.

In order to correct such an adjusting power disorder, as shown in FIG. 1B, by role-sharing of the right and left eyes for the far vision and the near vision, the right and left eyes are set in an anisometropic state. Thus, if compared with a case of the adjusting power disorder, the width of the distance (see W in the figure) in which an object can be focused, can be virtually widened. Further, when the right and left eyes are forcibly set in the anisometropic state by the monovision prescription, the visual acuity of each of the right and left eyes (see a peak height of a curve shown in the figure) can be gained, compared with a case that the adjusting power disorder due to presbyopia can be corrected while maintaining the isometropic state of the right and left eyes using a multifocal lens for example.

Note that in the monovision prescription shown in FIG. 1B, wearing on each of the right and left eyes a monofocal lens having a different focal length, is assumed. However, the monovision is not necessarily limited to the monofocal lens, and can be applied to a case of using the multifocal lens. In an example shown in FIG. 1C, it is assumed that the multifocal lens having the property suitable for the far vision (for example the ratio of a light quantity for the far vision and the near vision is 7:3), and the multifocal lens having the property suitable for the near vision (for example, the ratio of the light quantity for the far vision and the near vision is 3:7), are respectively worn on each of the right and left eyes. In FIG. 1C, a difference in the visual acuity of the right and left eyes in each distance is smaller than that of FIG. 1B. The inventors of the present invention consider as follows: namely, as the difference is larger in images viewed by each of the right and left eyes, the uncomfortable feeling through the binocular vision is likely to be larger. Therefore, as shown in FIG. 1C, the difference in visual acuities of both eyes becomes smaller than that of the case of the monofocal lens (see FIG. 1B), and therefore the uncomfortable feeling through the binocular vision can be reduced. Even in a case of such a monovision prescription, the width of the distance (see W in the figure) in which an object can be focused, can be spuriously widened, compared with a case if the adjusting power disorder.

Namely, in the case of the monovision prescription, the adjusting power disorder due to presbyopia is corrected by setting a state that the relation between the point spread function and the distance is different in right and left eyes by wearing the prescribed lens, irrespective of whether the prescribed lens is the monofocal lens or the multifocal lens.

Such a monovision prescription is mainly applied to a case that a contact lens or IOL is worn. However, the monovision prescription is not necessarily limited to such a lens, and the monovision prescription can also be applied to spectacle lenses.

### 2. SYSTEM STRUCTURE

A system structure of the simulation device according to this embodiment will be described next.

The simulation device according to this embodiment performs simulation processing so that the examinee can experience a view through the binocular vision in the monovision prescription state. In order to perform such simulation processing, the simulation device of this embodiment includes the system structure (hardware structure) as described below.

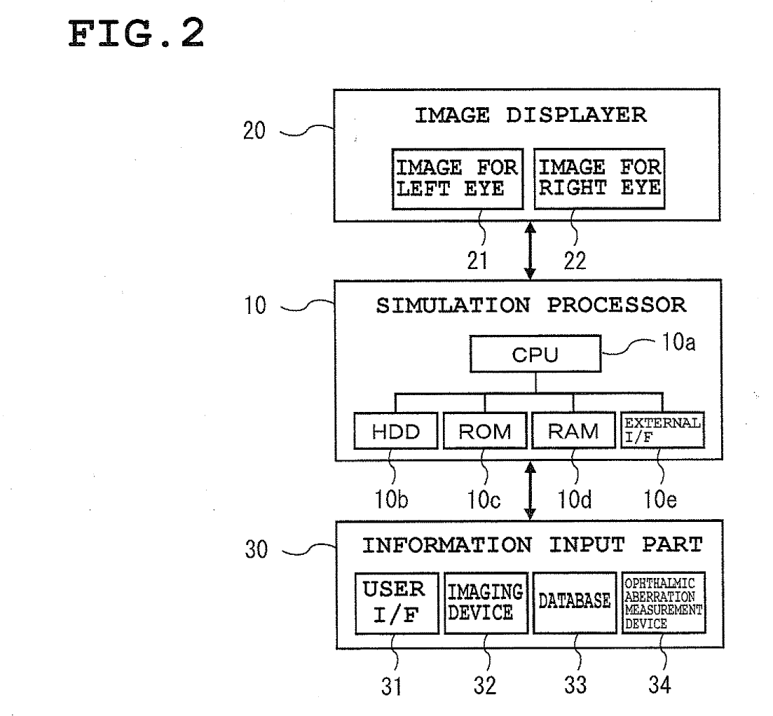

FIG. 2 is a block diagram showing an example of the system structure of the simulation device according to this embodiment. As shown in the figure, the simulation device of this embodiment roughly includes a simulation processor 10, an image displayer 20, and an information input part 30.

### (Simulation Processor)

The simulation processor 10 has a function as a computer device that performs information processing indicated by a prescribed program by executing a prescribed program, and specifically includes a combination of CPU (Central Processing unit) 10a, HDD (Hard disk drive) 10b, ROM (Read Only Memory) 10c, RAM (Random Access Memory) 10d, and an external interface 10e (abbreviated as “I/F” hereafter) represented by USB (Universal Serial Bus) for example. Note that in the simulation processor 10, information processing (for example, calculation processing and image generation processing as will be described later) which are required for the simulation processing, is performed for the examinee, by executing the simulation program stored in the HDD 10b, etc., by the CPU 10a.

### (Image Displayer)

The image displayer 20 performs image display so that the examinee can experience the view through the binocular vision in the monovision prescription state while following a control indicated by the simulation processor 10. Therefore, the image displayer 20 is configured to individually display an image 21 for a left eye and an image 22 for a right eye, for each of the right and left eyes of the examinee. Namely, the image displayer 20 realizes a function as an “image displayer” in the present invention.

Any kind of a hardware structure can be used, provided that the image displayer 20 can perform individual display of the image 21 for the left eye and the image 22 for the right eye, for each of the right left eyes of the examinee. Specific examples thereof are listed as follows. However, it is a matter of course that the image displayer 20 is not limited thereto.

As one of the examples, a frame sequential system can be given, which is a system of alternately displaying the image 21 for the left eye and the image 22 for the right eye in time-division. In the frame sequential system, a combination of either one of an image display device represented by a flat panel display device and an image projection device represented by a projector device, and a liquid crystal shutter spectacle worn by the examinee, is utilized. Then, the image display device or the image projection device alternately displays the image 21 for the left eye and the image 22 for the right eye at a short interval. Meanwhile, the liquid crystal shutter spectacle closes a liquid crystal shutter of a right eye when the image 21 for the left eye is displayed, and closes a liquid crystal shutter for the left eye when the image 22 for the right eye is displayed, by adjusting the timing to the image display device or the image projection device. By repeating this operation at a high speed (for example, 60 times per second), a mutually different image is viewed by the right and left eyes of the examinee.

As other example, a polarization system can be given, which is a system of displaying the image 21 for the left eye and the image 22 for the right eye, for the right and left eyes of the examinee, by using a light in which a vibration plane of a wave shows dissymmetries. In the polarization system, either one of the image display device represented by the flat panel display device and the image projection device represented by the projector device and polarized glasses worn by the examinee, are utilized. Then, a polarizing filter is stuck to the image display device or the image projection device, so that a polarizing direction is inclined by 90° in a striped pattern or a lattice pattern. Meanwhile, the polarizing direction of the polarized glasses is inclined by 90° in the right and left eyes. Accordingly, mutually different images in the right and left eyes of the examinee, can be viewed through the polarized glasses.

Further, a spectroscopic type can be given as other example, in which the image 21 for the left eye and the image 22 for the right eye are displayed with a light having a different wavelength, and the displayed images are viewed through a spectrum division glass. In this spectroscopic type, the combination of either one of the image display device represented by a flat panel display device or the image projection device represented by a projector device, and the spectrum division glass worn by the examinee, is utilized. Then, the image display device or the image projection device displays the image 21 for the left eye and the image 22 for the right eye with a light having a different wavelength. Meanwhile, the spectrum division glass allows a light having a specific plurality of wavelengths to pass through each of the right and left eyes. Accordingly, a mutually different image can be viewed by the right and left eyes of the examinee.

Further, as other example, a parallax barrier type utilizing an obstacle having a fine stripe pattern (such as a liquid crystal shutter, etc.) can be given. In the parallax barrier type, a parallax barrier layer as a minute obstacle for example, is arranged at a panel side of the image display device. With this structure, the image 21 for the left eye does not reach the right eye of the examinee, and the image 22 for the right eye does not reach the left eye of the examinee. Accordingly, the mutually different image can be viewed by the right and left eyes of the examinee even by a naked eye. The parallax barrier type is suitable for the purpose of use of the image display device for a mobile device for example, in which a distance from a display screen to the examinee is substantially determined.

Further, as other example, a head mount display (abbreviated as “HMD” hereafter) can be given. The HMD is configured to allow the right and left eyes of the examinee to view the mutually different image by wearing it on a head portion of the examinee.

### (Information Input Part)

The information input part 30 is configured to input information for the simulation processor 10 as needed. Specifically, user I/F 31 such as a keyboard and a mouse, etc., operated by an operator of the simulation device, an imaging device 32 such as a CCD (Charge Coupled Device) camera, etc., for acquiring an original image to be displayed for the examinee, a database 33 for previously storing and accumulating data regarding a prescribed lens, and an ophthalmic aberration measurement device 34, etc., for measuring aberration of an eyeball of the examinee, can be given as the information input part 30. Note that any one of them may be configured utilizing a publicly-known technique, and therefore more detailed explanation is omitted here.

### 3. FUNCTIONAL STRUCTURE

Next, explanation is given for a functional structure of the simulation processor 10 which is required for executing the simulation processing by the simulation device of this embodiment.

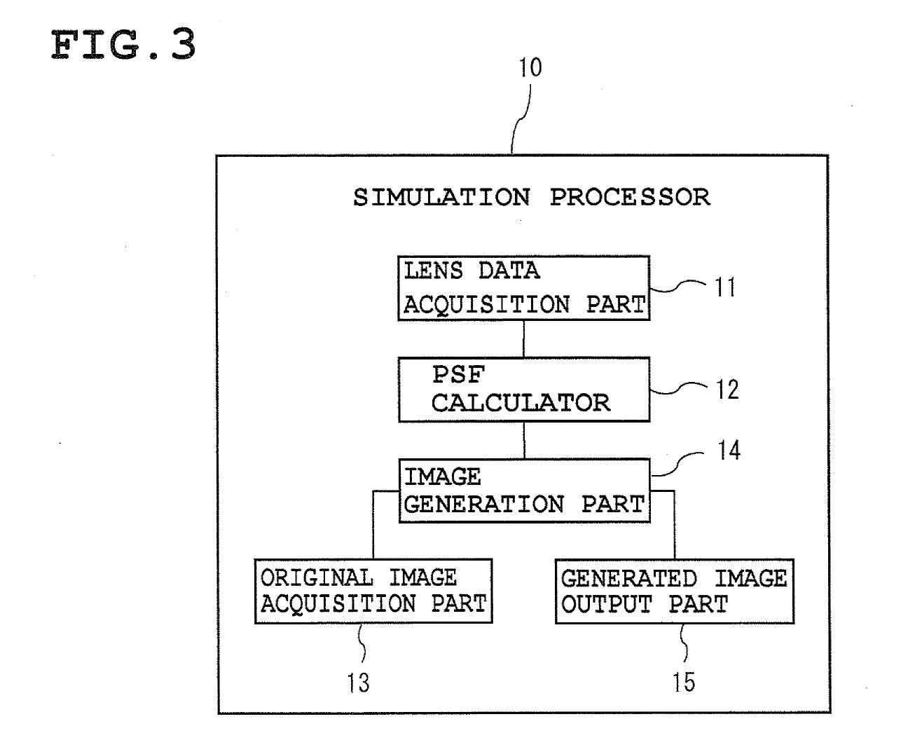

FIG. 3 is a block diagram showing an example of the functional structure in the simulation processor 10 included in the simulation device of this embodiment. As shown in the figure, in the simulation processor 10, functions of a lens data acquisition part 11, a PSF calculator 12, an original image acquisition part 13, an image generation part 14, and a generated image output part 15 are realized by executing the simulation program by the CPU 10a, which is the simulation program stored in the HDD 10b.

### (Lens Data Acquisition Part)

The lens data acquisition part 11 acquires data regarding a lens which is prescribed in the monovision prescription state, for example by accessing the database 33 while following an operation content by the user I/F 31, or by reading data stored and held in the HDD 10B of the simulation processor 10. The data regarding the lens includes the data for designing a lens, and the data regarding the recognition mode parameter when using the lens. The data for designing the lens includes each data for specifying a plane shape, refractive index, and thickness of the lens. Further, the data regarding the recognition mode parameter when using the lens, includes each data for specifying the focal length and a F-value (corresponding to a pupil diameter). Note that the data regarding the lens may also include data other than the above-mentioned data. Further, the lens data acquisition part 11 may also acquire other data, in addition to the data regarding the lens. As such other data, the data regarding a measurement result obtained by the ophthalmic aberration measurement device, can be given.

### (PSF Calculator)

The PSF calculator 12 obtains the point spread function (abbreviated as “PSF” hereafter) in the view through the lens prescribed in the monovision prescription state, by performing calculation processing, while using the data acquired by the lens acquisition part 11 (particularly the data for designing the lens and the data regarding the recognition mode parameter when using the lens). The PSF means the point spread function of a point light source by an optical system. More specifically, when a light passes through a certain optical system, the light from an object point forms a light distribution which is spread in a certain range around a center of an image point, and such alight distribution corresponds to the PSF. The PSF can be obtained by Fourier-transforming a wave front aberration and a pupil function expressed by an amplitude distribution on a pupil. A publicly-known technique disclosed in patent document 1 is used as a specific calculation technique, and therefore detailed explanation is omitted here.

### (Original Image Acquisition Part)

The original image acquisition part 13 acquires original image data to be displayed for the examinee, when providing the examinee a virtual experience of a view through the binocular vision in the monovision prescription state. The original image data is probably acquired by reading stored data from the HDD 10b of the simulation processor 10. However, the original image data may be acquired together or completely separately by receiving the data imaged by the imaging device 32. The acquired original image data may be the same for the right eye and the left eye of the examinee. However, the original image data having a mutually different parallax in the right and left eyes of the examinee is prepared, and it can be considered that a converging angle of the right and left eyes is taken into consideration in each data, and in this case, this original image data can respond to a stereoscopic image called 3D.

### (Image Generation Part)

The image generation part 14 creates the image 21 for the left eye and the image 22 for the right eye, by applying prescribed image processing to the original image data acquired by the original image acquisition part 13, based on a calculation result of the PSF by the PSF calculator 12. Namely, the image generation part 14 creates the image 21 for the left eye and the image 22 for the right eye viewed by the right and left eyes through the prescribed lens, when the relation between the PSF and the distance is set in a different state in the right and left eyes by wearing the lens in the monovision prescription state, and therefore the image generation part 14 functions as the “image generation part” in the present invention.

The image 21 for the left eye and the image 22 for the right eye generated by the image generation part 14 are used for verifying the uncomfortable feeling through the binocular vision in the monovision prescription state, and these images are mutually different two images because the PSF of the lens prescribed in the monovision prescription state is different between the right and left eyes, for example even if the original image data is the same in the right and left eyes of the examinee. More specifically, owing to the role-sharing by the right and left eyes for the far vision and the near vision in the monovision prescription state, one of the image 21 for the left eye and the image 22 for the right eye is the image for the far vision, and the other image is the image for the near vision. Further, in the monovision prescription state, prescription is applied to the lens, for example so that the dominant eye is corrected so as to be suitable for the far vision, and the non-dominant eye is corrected so as to be suitable for the near vision, and therefore one of the image 21 for the left eye and image 22 for the right eye is the image for the dominant eye, and the other image is the image for the non-dominant eye.

### (Generated Image Output Part)

The generated image output part 15 displays and outputs on/to the image displayer 20, the image 21 for the left eye and the image 22 for the right eye generated by the image generation part 14. Therefore, the generated image output part 15 performs data transmission to the image displayer 20 in a data form and at a transmission timing, in a manner appropriate for the image displayer 20.

### (Simulation Program)

Each of the above-mentioned parts 11 to 15 are realized by executing the simulation program by the simulation processor 10 having a function as a computer device. In this case, the simulation program is used by being installed in the HDD 10b, etc., of the simulation processor 10. However, prior to the install, the simulation program may be provided through a communication line connected to the simulation processor 10, or may be provided by being stored in a memory medium that can be read by the simulation processor 10.

### 4. SIMULATION PROCEDURE

Next, explanation is given for a procedure of executing the simulation processing by the simulation device having the above-mentioned structure, which is performed for verifying the uncomfortable feeling through the binocular vision in the monovision prescription state

In order to provide the virtual experience of the view to the examinee through the binocular vision in the monovision prescription state, the simulation device of this embodiment performs simulation processing based on a procedure described below.

### (Basic Processing Procedure)

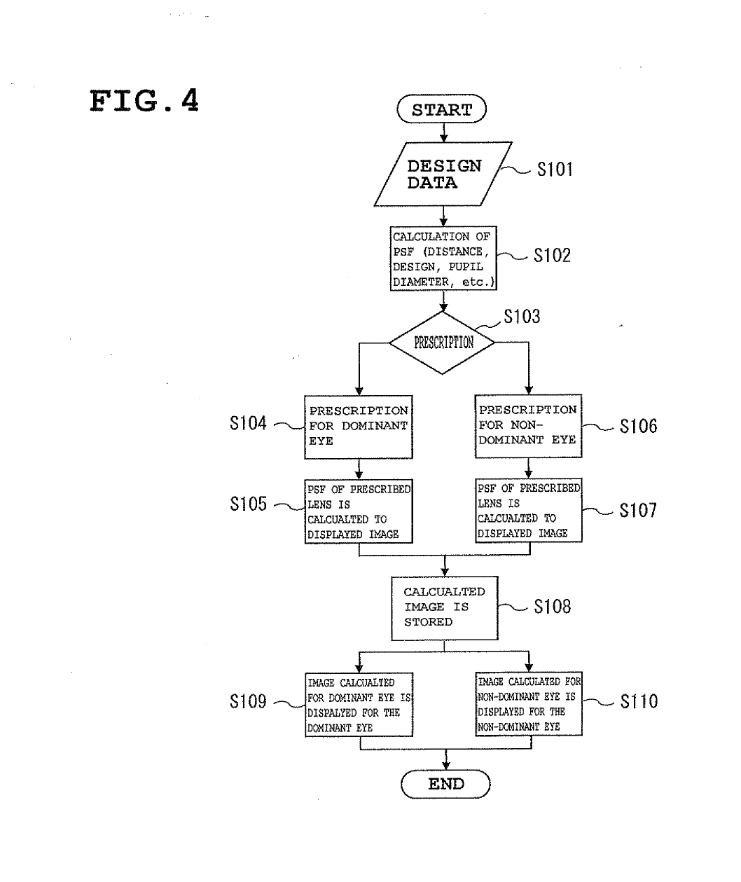

FIG. 4 is a flowchart showing an example of the procedure of the simulation processing performed by the simulation device of this embodiment.

As shown in the figure, first, the lens data acquisition part 11 acquires the data regarding the prescribed lens in the monovision prescription state (step 101, the step is abbreviated as “S” hereafter). Specifically, lens design data including each data for specifying at least the plane shape, the refractive index, and the thickness of the prescribed lens is acquired. Further, each data for specifying at least the focal length and the F-value when using the lens, is acquired as the data regarding the recognition mode parameter when using the lens. This is because the PSF for the view through the prescribed lens, is determined based on each data.

When the lens data acquisition part 11 acquires the data, subsequently the PSF calculator 12 calculates and obtains the PSF for the view through the lens which is prescribed in the monovision prescription state, while using the acquired design data, focal length, and F-value, etc. (S102).

Meanwhile, the original image acquisition part 13 acquires the original image data to be displayed for the examinee. At this time, the original image data acquired by the original image acquisition part 13 may be the same for the right and left eyes of the examinee, provided that the same object is viewed by the right and left eyes of the examinee for example. Then, when the PSF calculator 12 calculates the PSF, and the original image acquisition part 13 acquires the original image data, the image generation part 14 thereafter determines which type of the prescription is assumed for the dominant eye and the non-dominant eye of the examinee (S103), and creates the image 21 for the left eye and the image 22 for the right eye by following the determination. Specifically, regarding the dominant eye of the examinee, the prescription for the dominant eye is grasped (S104), and based on the calculation result of the PSF by the PSF calculator 12 responding to the prescription content, and by applying prescribed image processing to the original image data acquired by the image acquisition part 13, one of the image 21 for the left eye and the image 22 for the right eye is created (S105). Further, regarding the non-dominant eye of the examinee, the prescription for the non-dominant eye is grasped (S106), and based on the calculation result of the PSF by the PSF calculator 12 responding to the prescription content, and by applying prescribed image processing to the original data acquired by the original image acquisition part 13, the other image of the image 21 for the left eye and the image 22 for the right eye is created (S107).

At this time, blur processing called a convolution for example can be given as prescribed image processing performed by the image generation part 14. In the blur processing, brightness of each element in an original image is distributed to circumferential elements based on a calculation result of the PSF, to thereby re-construct the brightness of all elements. Thus, the image generated through the blur processing is the image in which a blur state corresponding to the PSF is reflected. A specific technique of the blur processing (convolution) is a publicly-known technique, and therefore detailed explanation therefore is omitted here. Further, the prescribed image processing performed by the image generation part 14 is not necessarily required to be the blur processing (convolution), and the image may be generated by performing other image processing, if the blur state corresponding to the PSF can be reflected.

When such a prescribed image processing is performed, the image generation part 14 temporarily stores and holds the image 21 for the left eye and the image 22 for the right eye obtained by the prescribed image processing, in the HDD 10b and the RAM 10d, etc., of the simulation processor 10 (S108).

Thereafter, the generated image output part 15 performs data transmission regarding the image 21 for the left eye and the image 22 for the right eye generated by the image generation part 14 and temporarily stored and held in the HDD 10b and the RAM 10d, to the image displayer 20 in a data form and at a transmission timing corresponding to the image displayer 20. By receiving the data, the image displayer 20 displays the image 21 for the left eye and the image 22 for the right eye, individually for each of the right and left eyes of the examinee. For example, when the prescription of correcting the dominant eye (left eye) prescribed so as to be suitable for the far vision and the prescription of correcting the non-dominant eye (right eye) prescribed so as to be suitable for the near vision, is provided to the examinee whose left eye is the dominant eye and right eye is the non-dominant eye, the image displayer 20 provides the image 21 for the left eye being the image obtained by arithmetic operation for the dominant eye, to the left eye being the dominant eye of the examinee (S109), and provides the image 22 for the right eye being the image obtained by arithmetic operation for the non-dominant eye, to the right eye being the non-dominant eye of the examinee (S110).

By performing the simulation processing based on the procedure as described above, the image 21 for the left eye and the image 22 for the right eye is individually provided to each of the right and left eyes of the examinee. Accordingly, the examinee can have a virtual experience through the binocular vision in the monovision prescription state. Thus, the uncomfortable feeling through the binocular vision in the monovision prescription state (whether or not the examinee has a feeling of flickering) can be verified.

### (List Form Image)

Incidentally, in the procedure of the above-mentioned series of simulation processing, it is assumed that one lens prescription is applied to the right and left eyes of the examinee. However, in the image 21 for the left eye and the image 22 for the right eye, image elements corresponding to each lens prescription are shown in a list form in the same image, on the assumption that there are mutually different plurality of lens prescriptions. More specifically, when the focal length and the pupil diameter, etc., are different as the mutually different lens prescriptions, namely, when the recognition mode parameter is different, such a difference is estimated to calculate the PSF corresponding to each difference. Then, a plurality of image elements based on the PSF corresponding to each difference, are generated by convolution, etc., and the generated plurality of image elements are arranged in the list form.

Thus, when the image 21 for the left eye and the image 22 for the right eye in which a plurality of image elements with different recognition mode parameters are shown in the list form, are generated and provided to the right and left eyes of the examinee, the examinee can have the virtual experience of the view all at once, which is the view different in accordance with a difference in the recognition mode parameters. Namely, the uncomfortable feeling through the binocular vision in the monovision prescription state can be verified while comparing the view of each image element which is different in accordance with the difference in the recognition mode parameters. Accordingly, the examinee can easily and precisely verify the uncomfortable feeling through the binocular vision in the monovision prescription state. Further, by displaying the image in the list format the side of the simulation device, there is no necessity for repeatedly executing a series of aforementioned simulation processing even in a case that re-display of the image is required due to the uncomfortable feeling of the examinee for example. Therefore a processing load can be preferably reduced.

### (Other Consideration Matter)

Further, it can be considered that the image generation part 14 generates the image 21 for the left eye and the image 22 for the right eye in consideration of the following point.

The image generation part 14 may also generate the image 21 for the left eye and the image 22 for the right eye in consideration of an angle corresponding to a size of the image element and an angle corresponding to an interval between adjacent image elements. Specifically, when a plurality of image elements are shown in the list form in the same image, it can be considered that each displayed image element is arranged having an angle so that a certain image element and the other image element are not influenced each other. In order not to be influenced each other in the same image, the image elements are preferably arranged separately in such a manner as having an angle of 4° or more. With this arrangement having such an angle, each element is prevented from being influenced each other even in a case that a plurality of image elements are arranged in the list form in the same image. Therefore, precision is more improved in verifying the uncomfortable feeling through the binocular vision, which is felt by the examinee.

The image generation part 14 may determine the sizes of the generated image 21 for the left eye and the generated image 22 for the right eye, in consideration of a distance between the right and left eyes of the examinee and an image display surface (display image) displayed by the image displayer 20. Specifically, the size of the display image is changed corresponding to the distance, so as to be a size of a retinal image which is estimated when PSF is assigned thereto, irrespective of whether the image 21 for the left eye and the image 22 for the right eye respond to one lens prescription or whether a plurality of image elements are shown in the list form. Thus, by selecting the magnitude of the display image, the retinal image estimated when PSF is assigned can be viewed by the examinee. Therefore, precision is more improved in verifying the uncomfortable feeling through the binocular vision, which is felt by the examinee.

Further, the image generation part 14 may also generate the image 21 for the left eye and the image 22 for the right eye, in consideration of the converging angle of the right and left eyes corresponding to the distance between the right and left eyes of the examinee and the image display surface (display image) displayed by the image displayer 20. Specifically, it can be considered that the converging angle is changed corresponding to the distance, irrespective of whether the image 21 for the left eye and the image 22 for the right eye respond to one lens prescription or whether a plurality of image elements are shown in the list form. By thus generating the display image, the image generation part 14 can respond to a stereoscopic image called 3D. Namely, a stereoscopic feeling of the display image can be reproduced to the examinee.

Further, the image 21 for the left eye and the image 22 for the right eye may be generated, in consideration of the data regarding the measurement result of the ophthalmic aberration measurement device 34. Specifically, when the image 21 for the left eye and the image 22 for the right eye are generated, it can be considered that the aberration correction is performed based on the measurement result of the aberration of the eyeball of the examinee. Thus, the influence of the aberration of the eyeball of the examinee (namely individual variation) can be excluded. Therefore, precision is more improved in verifying the uncomfortable feeling through the binocular vision, which is felt by the examinee.

### 5. SPECIFIC EXAMPLE OF SIMULATION

Next, explanation is given for the result of the simulation processing by the above-mentioned series of procedure, namely regarding the display image displayed by the image displayer 20 by the simulation processing, with first to sixth examples given as specific examples thereof. Here, the explanation is given as follows, on the assumption that the monovision processing is applied to a contact lens or IOL. Note that in the simulation processing in this embodiment, the image is generated by performing the image processing in consideration of the characteristics of the monovision prescription. Therefore, if the characteristics of a target monovision prescription are the same as a result, display images displayed for the examinee are respectively the same, although there is a difference between the contact lens and IOL.

### FIRST EXAMPLE

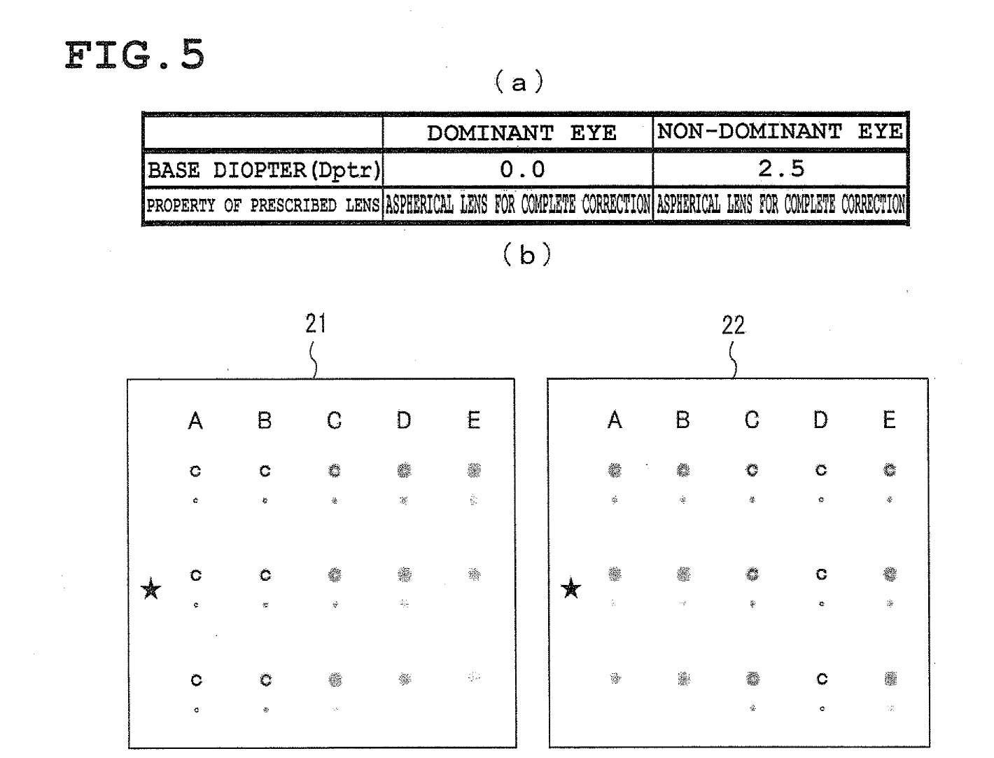

FIG. 5 is an explanatory view showing a first example of a result of performing the simulation processing using the simulation device according to this embodiment.

In the first example, when the left eye of the examinee is the dominant eye and the right eye of the examinee is the non-dominant eye, as shown in FIG. 5A, an example of the monovision prescription is given, in which a monofocal aspherical surface lens is used for each of the right and left eyes, then the aberration correction is applied to both eyes, so that the dominant eye and the non-dominant eye have different spherical diopters by 2.5D. In a case of such a monovision prescription, it can be considered that the image 21 for the left eye and the image 22 for the right eye shown in FIG. 5B are generated.

The image 21 for the left eye and the image 22 for the right eye in the figure show a plurality of image elements in the list form, wherein the recognition mode parameters are different. “A” to “E” in each of the images 21 and 22 correspond to a difference of objective distance. Specifically, “A” corresponds to 0.0 [Dptr], “B” corresponds to 0.5 [Dptr], “C” corresponds to 1.5 [Dptr], “D” corresponds to 2.5 [Dptr], and “E” corresponds to 4.0 [Dptr]. Further, Landolt C being an example of the image elements are arranged in a lower side of “A” to “E” so as to be divided into three stages of upper, middle, and lower stages, on the assumption that the upper stage indicates a pupil diameter of φ2.0, the middle stage indicates a pupil diameter of φ3.0, and the lower stage indicates a pupil diameter of φ4.0 respectively. Further, large and small two Landolt C are arranged at each place, on the assumption that a large Landolt C corresponds to a visual acuity of 0.2, and a small Landolt C corresponds to a visual acuity of 0.5. Note that specific numerical values, etc., of the object distance and the pupil diameter are not shown in the images 21 and 22, so as not to excessively give unnecessary information to the examinee.

Thus, even though the image 21 for the left eye and the image 22 for the right eye in the figure are based on the same image in which the Landolt C are arranged in three lines and five rows in each image, the PSF is different in each of the images for the left eye and the right eye, and further in each of Landolt C in the images 21 and 22. Therefore, the blur state is also different. Such a difference in the blur state is reproduced by the calculation of PSF and the prescribed image processing based on the calculation result, in the image 21 for the left eye and the image 22 for the right eye which are the images created by the simulation processing of this embodiment.

Then, the created image 21 for the left eye and image 22 for the right eye are displayed for the examinee by the image displayer 20. At this time, the image 21 for the left eye and the image 22 for the right eye are individually displayed for each of the right and left eyes of the examinee. Accordingly, the examinee can have the virtual experience of the view through the binocular vision in the monovision prescription state. Thus, the uncomfortable feeling through the binocular vision in the monovision prescription state (whether or not the examinee has a feeling of flickering) can be verified. Such a verification cannot be performed, for example if both the image 21 for the left eye and the image 22 for the right eye are simultaneously viewed by either one of the right and left eyes, or if either one of the image 21 for the left eye and the image 22 for the right eye is viewed by both of the right and left eyes simultaneously. Namely, the verification can be realized for the first time by displaying the image 21 for the left eye and the image 22 for the right eye by the image displayer 20, individually for each of the right and left eyes.

Note that in the image 21 for the left eye and the image 22 for the right eye given as examples here, the difference in the recognition mode parameters is shown in the list form by each Landolt C arranged in three lines and five rows. Therefore, the examinee can have the virtual experience of the view all at once, which is the view different in accordance with the difference in the object distance and the pupil diameter, etc.

### SECOND EXAMPLE

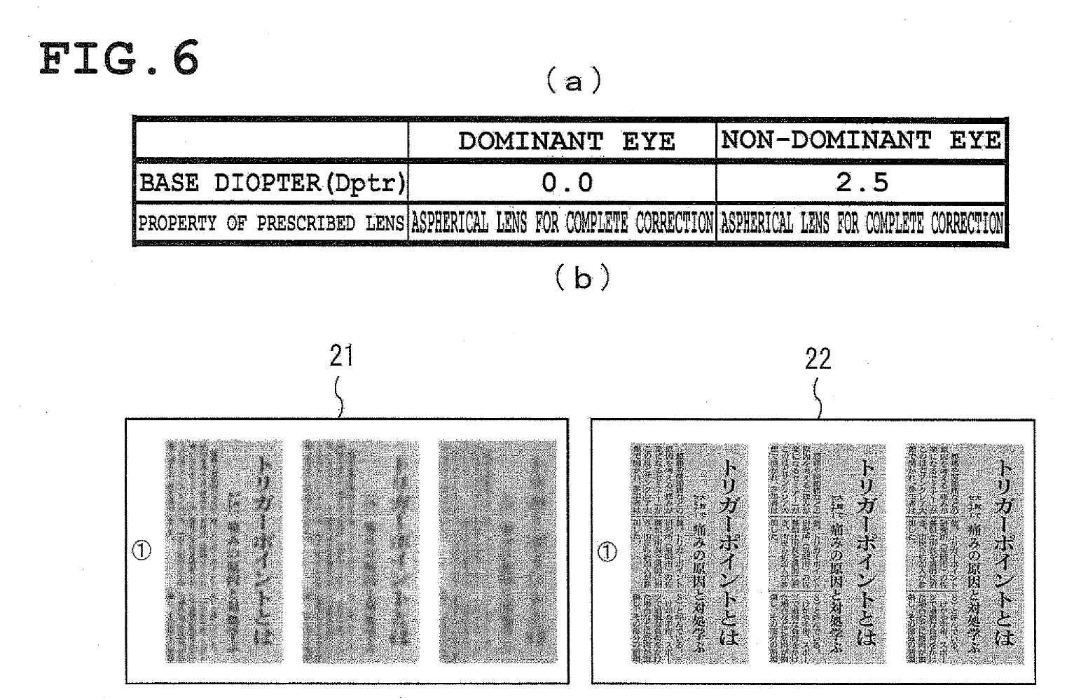

FIG. 6 is an explanatory view showing a second example of a result of performing the simulation processing using the simulation device of this embodiment.

In the second example as well, as shown in FIG. 6A, the monovision prescription state similar to that of the first example, is given as an example. In such a monovision prescription state, it can be considered that the image 21 for the left eye and the image 22 for the right eye shown in FIG. 6B are generated.

The image 21 for the left eye and the image 22 for the right eye shown in the figure estimate the view in a case that a part of a newspaper article, being other example of the image element, is placed so as to correspond to the object distance of 2.5 [Dptr]. Further, three newspaper articles are arranged in each of the image 21 for the left eye and the image 22 for the right eye, on the assumption that the pupil diameter is φ2.0, the pupil diameter is φ3.0, and the pupil diameter is φ4.0 from the left side of the figure.

Thus, even though the image 21 for the left eye and the image 22 for the right eye in the figure are based on the same image of a part of the newspaper article, PSF is different in each of the images for the left eye and for the right eye, and further in each of the three arranged newspaper articles in the images 21 and 22. Therefore, the blur state is also different. Such a difference in the blur state is reproduced by the calculation of PSF and the prescribed image processing based on the calculation result in the image 21 for the left eye and the image 22 for the right eye which are created by the simulation processing of this embodiment.

Then, the created image 21 for the left eye and image 22 for the right eye are displayed individually for each of the right and left eyes of the examinee. Accordingly, the examinee can verify the uncomfortable feeling through the binocular vision in the monovision state, through the view of the newspaper article in a near distance. As described in the first example, the verification can be realized for the first time by displaying the image 21 for the left eye and the image for the right eye by the image displayer 20, individually for each of the right and left eyes.

Note that in the image 21 for the left eye and the image 22 for the right eye given as examples here, the difference in the recognition mode parameters is shown in the list form by each Landolt C arranged in three lines and five rows. Therefore, the examinee can have the virtual experience of the view of the newspaper in the near distance (distance of 2.5D) all at once, including the difference in the pupil diameter.

### THIRD EXAMPLE

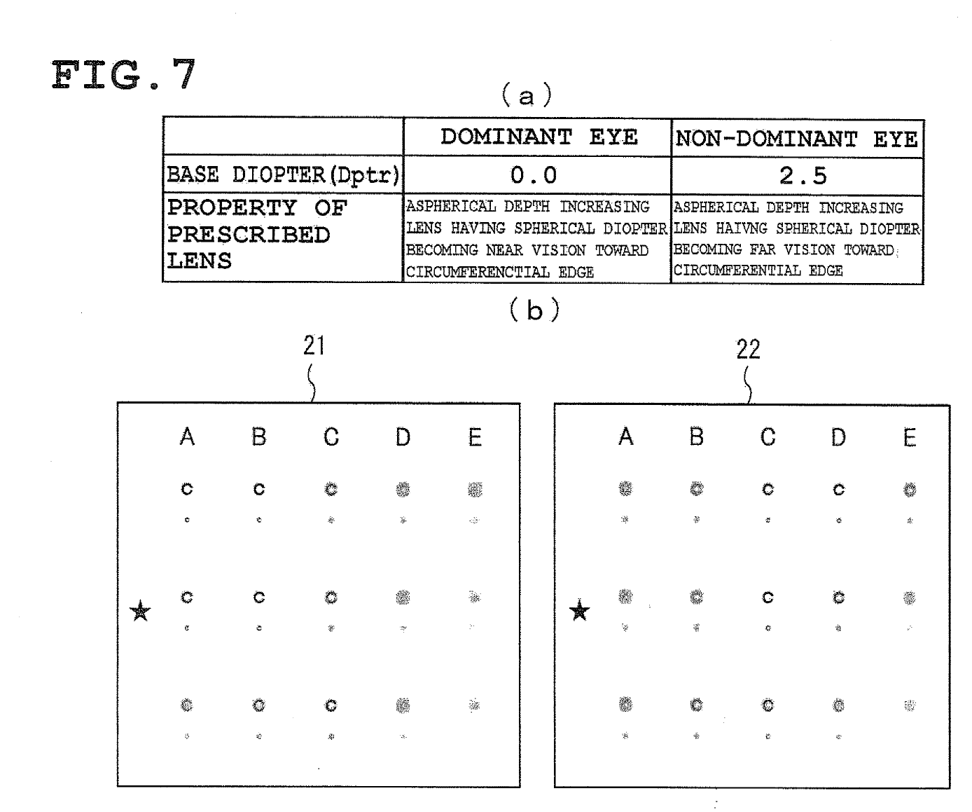

FIG. 7 is an explanatory view showing a third example of the result of performing the simulation processing using the simulation device of this embodiment.

In the third example, explanation is given for a case that the left eye of the examinee is the dominant eye, and the right eye of the examinee is the non-dominant eye, and the monovision prescription is performed for both eyes using the lens having a refractive power to both eyes. Specifically, as shown in FIG. 7A, explanation is given for an example of the monovision prescription as follows: an aspherical depth increasing lens with the spherical diopter becoming the diopter for a near vision toward a circumference of the lens is used for the dominant eye, and the aspherical depth increasing lens with the spherical diopter becoming the diopter for a far vision toward the circumference of the lens is used for the non-dominant eye, so that the dominant eye and the non-dominant eye have different spherical diopters by 2.5D. In such a monovision prescription state, it can be considered that the image 21 for the left eye and the age 22 for the right eye are generated as shown in FIG. 7B.

Similarly to the case of the first example, the Landolt C is arranged in three lines and five rows in the image 21 for the left eye and the image 22 for the right eye in the figure, and the difference in the blur state of each Landolt C is reproduced by the calculation of the PSF and the prescribed image processing based on the calculation result. Then, the examinee can verify the uncomfortable feeling through the binocular vision in the monovision prescription state by displaying the image 21 for the left eye and the image 22 for the right eye for each of the right and left eyes of the examinee individually. As described in the first example and the second example, the verification can be realized for the first time by displaying the image 21 for the left eye and the image 22 for the right eye by the image displayer 20, individually for each of the right and left eyes.

Note that in the image 21 for the left eye and the image 22 for the right eye given as examples here, the difference in the recognition mode parameters is shown in the list form by each Landolt C arranged in three lines and five rows. Therefore, the examinee can have the virtual experience of the view all at once, which is the view different in accordance with the difference in the object distance and the pupil diameter, etc.

### FOURTH EXAMPLE

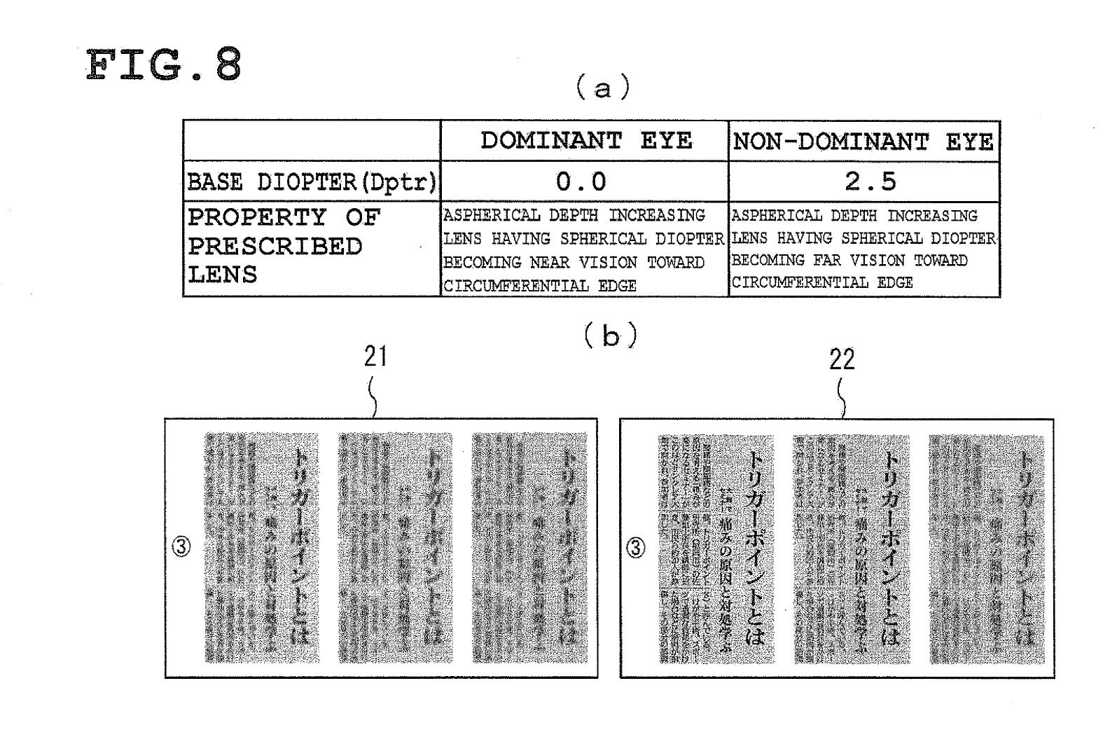

FIG. 8 is an explanatory view showing a fourth example of the result of performing the simulation processing using the simulation device of this embodiment.

In the fourth example as well, as shown in FIG. 8A, explanation is given for a case that the monovision prescription similar to the third example is performed. In such a monovision prescription state, it can be considered that the image 21 for the left eye and the image 22 for the right eye are generated as shown in FIG. 6B.

Similarly to the second example, a part of the newspaper article is arranged side by side in the image 21 for the left eye and the image 22 for the right eye, and the difference in the blur state of each newspaper article is reproduced by the calculation of the PSF and the prescribed image processing based on the calculation result. Then, the examinee can verify the uncomfortable feeling through the binocular vision in the monovision state, through the view of the newspaper article in the near distance, by displaying the image 21 for the left eye and the image 22 for the right eye individually for each of the right and left eyes of the examinee. As described in the first example to the third example, the verification can be realized for the first time by displaying the image 21 for the left eye and the image for the right eye by the image displayer 20, individually for each of the right and left eyes.

Note that in the image 21 for the left eye and the image 22 for the right eye given as examples here, the difference in the recognition mode parameters is shown in the list form by each of the three arranged newspaper articles. Therefore, the examinee can have the virtual experience of the view of the newspaper in the near distance (distance of 2.5D) all at once, including the difference in the pupil diameter.

### FIVE EXAMPLE

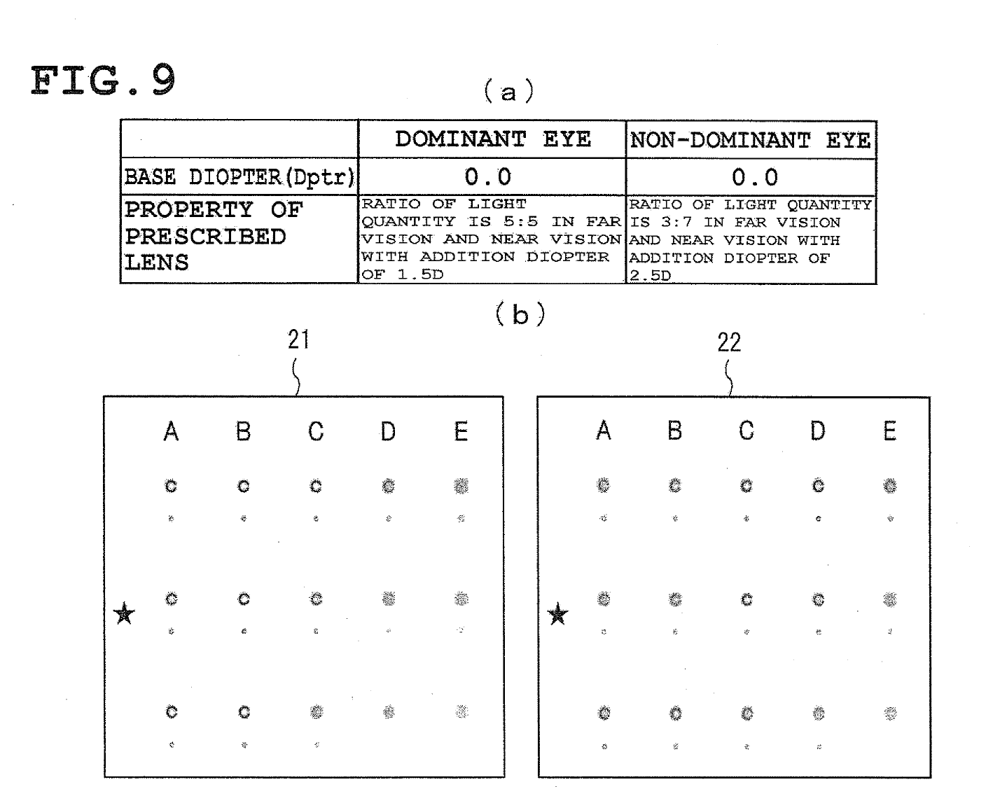

FIG. 9 is an explanatory view showing a fifth example of the result of performing the simulation processing using the simulation device of this embodiment.

In the fifth example, explanation is given for a case that the left eye of the examinee is the dominant eye, and the right eye of the examinee is the non-dominant eye, and the monovision prescription is performed to both eyes using a diffractive multifocal lens. The diffractive multifocal lens is a progressive type in which an addition diopter is varied in accordance with the pupil diameter. Specifically, as shown in FIG. 9A, explanation is given for the following example of the monovision prescription: the diffractive multifocal lens with the addition diopter being 1.5D and the ratio of a light quantity for the far vision and the near vision being 5:5, is used for the dominant eye, and the diffractive multifocal lens with the addition diopter being 2.5D and the ratio of the light quantity for the far vision and the near vision being 3:7, is used for the non-dominant eye, with no difference in far vision diopters between the dominant eye and the non-dominant eye. In such a monovision state, it can be considered that the image 21 for the left eye and the image 22 for the right eye are generated as shown in FIG. 9B.

Similarly to the case of the first example or the third example, the Landolt C is arranged in three lines and five rows in the image 21 for the left eye and the image 22 for the right eye in the figure, and the difference in the blur state of each Landolt C is reproduced by the calculation of the PSF and the prescribed image processing based on the calculation result. Then, the examinee can verify the uncomfortable feeling through the binocular vision in the monovision prescription state by displaying the image 21 for the left eye and the image 22 for the right eye individually for each of the right and left eyes of the examinee. As described in the first example to the fourth example, the verification can be realized for the first time by displaying the image 21 for the left eye and the image for the right eye by the image displayer 20, individually for each of the right and left eyes.

Note that in the image 21 for the left eye and the image 22 for the right eye given as examples here, the difference in the recognition mode parameters is shown in the list form using the Landolt C arranged in three lines and five rows. Therefore, the examinee can have the virtual experience of the view all at once, which is the view different in accordance with the difference in the object distance and the pupil diameter.

### SIXTH EXAMPLE

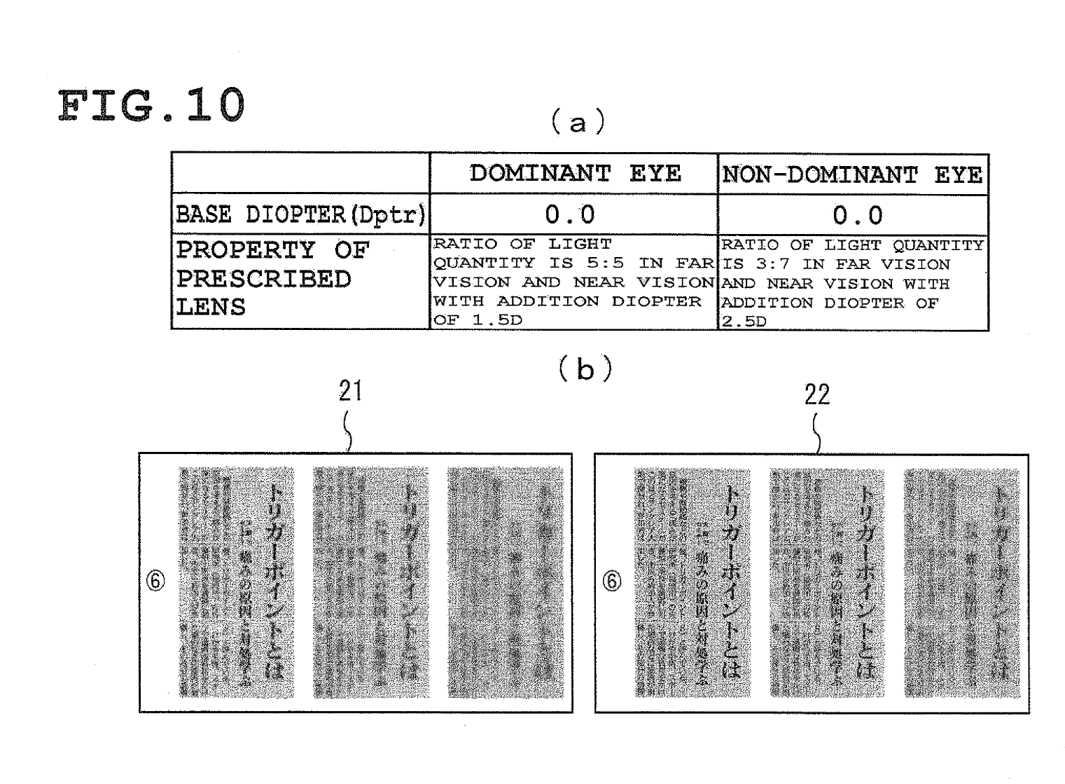

FIG. 10 is an explanatory view showing a sixth example of the result of performing the simulation processing using the simulation device of this embodiment.

In the sixth example as well, as shown in FIG. 10A, the monovision prescription state similar to that of the fifth example, is given as an example. In such a monovision prescription state, it can be considered that the image 21 for the left eye and the image 22 for the right eye are generated as shown in FIG. 10B.

Similarly to the second example or the fourth example, a part of the newspaper article is arranged side by side in the image 21 for the left eye and the image 22 for the right eye, and the difference in the blur state of each newspaper article is reproduced by the calculation of the PSF and the prescribed image processing based on the calculation result. Then, the examinee can verify the uncomfortable feeling through the binocular vision in the monovision state, through the view of the newspaper article in the near distance, by displaying the image 21 for the left eye and the image 22 for the right eye individually for each of the right and left eyes of the examinee. As described in the first example to the fifth example, the verification can be realized for the first time by displaying the image 21 for the left eye and the image 22 for the right eye by the image displayer 20, individually for each of the right and left eyes.

Note that in the image 21 for the left eye and the image 22 for the right eye given as examples here, the difference in the recognition mode parameters is shown in the list form by each of the three arranged newspaper article portions. Therefore, the examinee can have the virtual experience of the view of the newspaper in the near distance (distance of 2.5D) all at once, including the difference in the pupil diameter.

### 6. EFFECT OF THIS EMBODIMENT

According to the simulation device, the simulation program for operating the simulation device, and the simulation method executed by the simulation device, the following effect can be obtained.

In this embodiment, the image 21 for the left eye and the image 22 for the right eye are mutually different two images created for verifying the uncomfortable feeling through binocular vision in the monovision prescription state. Then, the image 21 for the left eye and the image 22 for the right eye are displayed individually for each of the right and left eyes of the examinee. Namely, the anisometropia is forcibly crated by making the examinee view the images different from each other. Therefore, according to this embodiment, the simulation processing is performed based on a new unconventional concept. Accordingly, whether the uncomfortable feeling is felt or not by the examinee through the binocular vision in the monovision prescription state, namely whether flickering is felt or not by the examinee due to a mismatch between a distant view image and a near view image, can be verified. Thus, the monovision prescription capable of eliminating the uncomfortable feeling can be applied to the examinee, by making the examinee have the virtual experience of the view in advance by simulation. Therefore, the monovision prescription is an extremely excellent prescription in usability for the examinee under the monovision prescription. Further, the side applying the monovision prescription can also easily perform a more excellent lens prescription by making the examinee have the virtual experience of the view, and applying the lens prescription thereto based on the virtual experience of the view. In addition, the examinee can have the virtual experience of the view by simulation, with no necessity for preparing an actually prescribed lens. In terms of this point as well, the extremely excellent usability can be obtained.

Further, in this embodiment, even in a case that the relation between the PSF and the distance is in a different state between the right and left eyes when wearing the lens in the monovision prescription state, mutually different image 21 for the left eye and image 22 for the right eye are generated as each image viewed by the right and left eyes through the lens in the monovision prescription state, and these image 21 for the left eye and image 22 for the right eye are displayed individually for each of the right and left eyes of the examinee. Therefore, the examinee can surely have the virtual experience of the view through the binocular vision in the monovision prescription state. The examinee cannot have such a virtual experience of the view when simultaneously viewing both of the image 21 for the left eye and the image 22 for the right eye by either one of the right and left eyes, or when viewing either one of the image 21 for the left eye and the image 22 for the right eye simultaneously by both eyes of the right and left eyes. The virtual experience of the view can be realized for the first time, by displaying the image 21 for the left eye and the image 22 for the right eye individually for each of the right and left eyes of the examinee. In order to display the image individually for each of the right and left eyes of the examinee, the image displayer 20 may be used, which is configured by utilizing, for example, a frame sequential system, a polarization system, a spectroscopic system, a parallax barrier system, HMD, or an image display technique similar to them. However, an object of these image display techniques is to respond to the stereoscopic view generally, and it is not easily achieved even by the skilled person, to use these techniques for the simulation processing for reproducing the anisometropic state of the right and left eyes, namely for the purpose of use other than display of the stereoscopic view image.

Further, in this embodiment, in order to reproduce a state that the relation between the PSF and the distance is different between the right and left eyes when wearing the lens in the monovision prescription state, PSF of the view through this lens is utilized. This is because by utilizing the PSF, the level of the generated blur state of the image viewed through the lens, can be surely specified in terms of the lens design. Therefore, such a state (namely a blur generation state) is precisely reflected on the image 21 for the left eye and the image 22 for the right eye generated based on the calculation result of the PSF, even if the relation between the PSF and the distance is a different state between the right eye and the left eye.

Further, as described in this embodiment, if the image 21 for the left eye and the image 22 for the right eye are generated, in which a plurality of image elements are shown in the list form wherein the recognition mode parameters are different, the examinee can have the virtual experience of the view of each image element, namely can have the virtual experience of the view all at once, which is the view different in accordance with the difference in the object distance and the pupil diameter, etc. Accordingly, the examinee can easily and precisely verify the uncomfortable feeling through the binocular vision in the monovision prescription state, and at the side of the simulation device as well, reduction of the processing load can be expected by reducing repeated processing.

Further, as described in this embodiment, in order to generate the image 21 for the left eye and the image for the right eye, precision of verifying the uncomfortable feeling through the binocular vision by the examinee can be improved, when an angle corresponding to the size of the image element and an angle corresponding to the interval between the adjacent image elements are taken into consideration.

Further, as described in this embodiment, even when the size of the image 21 for the left eye and the size of the image 22 for the right eye are determined in consideration of the distance between the right and left eyes of the examinee and the image display surface (display image) displayed by the image displayer 20, the improvement in the precision of verifying the uncomfortable feeling through the binocular vision by the examinee can be expected.

Further, as described in this embodiment, in order to generate the image 21 for the left eye and the image 22 for the right eye, the stereoscopic feeling of the display image can be reproduced for the examinee, when the converging angle of the right and left eyes corresponding to the distance between the right and left eyes of the examinee and the image display surface (display image) displayed by the image displayer 20, is taken into consideration.

Further, as described in this embodiment, in order to generate the image 21 for the left eye and the image 22 for the right eye, the influence of the aberration of the eyeball of the examinee “namely individual variation) can be excluded when the data regarding the measurement result using the ophthalmic aberration measurement device 34 is taken into consideration.

### 7. MODIFIED EXAMPLE, ETC.

The embodiment of the present invention is described above. However, the above-mentioned disclosed content shows an exemplary embodiment of the present invention. Namely, a technical scope of the present invention is not limited to the above-mentioned exemplary embodiment.

For example, when original image data is acquired using the imaging device 32, prescribed image processing is immediately applied to the acquired original image data, which is then displayed and outputted by the image displayer 20, to thereby configure a so-called real time simulation device. In this case, the simulation processor 10 functions as an image processing filter for generating the image 21 for the left eye from the acquired original image data, and an image processing filter for generating the image 22 for the right eye from this original image data.

Further, in this embodiment, mainly, in order to make the examinee view the same thing by the right and left eyes, an example of generating the image 21 for the left eye and the image 22 for the right eye from the same original image data, is given. However, this embodiment can also respond to the stereoscopic view called 3D by preparing the original image data for the left eye and the original image data for the right eye.

Further, this embodiment shows an example of generating the image 21 for the left eye and the image 22 for the right eye based on the PSF through the lens. However, image generation may also be performed by utilizing some other technique without utilizing the PSF, if the image can be generated, in which the view through this lens is reflected.

Further, this embodiment shows an example of a case that each of the image 21 for the left eye and the image 22 for the right eye is the image for the far vision and the image for the near vision. However, each of the images 21 and 22 is not necessarily required to respond to the far vision and the near vision, and may also respond to a near and intermediate distance and a near distance, etc., provided that a right and left anisometropic state in the monovision prescription state can be reproduced.

Further, this embodiment shows an example of a case that each of the image 21 for the left eye and the image 22 for the right eye is the image for the dominant eye and the image for the non-dominant eye. However, the present invention is not limited thereto. Namely, even in a case that the image is not sorted to the image for the dominant eye and the image for the non-dominant eye, the right and left eyes anisometropic state can be reproduced by applying the present invention.

1. A simulation device, comprising:
an image generation part configured to generate mutually different two images, as each image which is viewed by right and left eyes respectively through a lens in a monovision prescription state, when a relation between a point spread function and a distance is set in a different state by wearing the lens in the monovision prescription state; and
an image displayer configured to display the two different images generated by the image generation part individually for each of the right and left eyes of an examinee.

2. The simulation device according to claim 1, wherein the image generation part is configured to generate an image based on the point spread function in a case of viewing the image through the lens.

3. The simulation device according to claim 1, wherein the two images generated by the image generation part are an image for a far vision and an image for a near vision.

4. The simulation device according to claim 1, wherein the two images generated by the image generation part are an image for a dominant eye and an image for a non-dominant eye.

5. The simulation device according to claim 1, wherein the image generation part generates an image in which a plurality of image elements having different recognition mode parameters, are shown in a list form.

6. The simulation device according to claim 1, wherein the image generation part is configured to generate the two images in consideration of an angle corresponding to a size of each image element and an angle corresponding to an interval between adjacent image elements.

7. The simulation device according to claim 1, wherein the image generation part is configured to generate the image in consideration of a distance from the examinee to a display image displayed by the image displayer.

8. The simulation device according to claim 1, wherein the image generation part is configured to generate the two images in consideration of a converging angle of the right and left eyes corresponding to the distance from the examinee to the display image displayed by the image displayer.

9. The simulation device according to claim 1, which is used in combination with an ophthalmic aberration measurement device for measuring an aberration of an eyeball of the examinee.

10. A simulation device configured to display two mutually different images created for verifying an uncomfortable feeling in a view through a binocular vision in a monovision prescription state, for each of the right and left eyes.

11. A simulation program, for making a computer realize a simulation function of displaying a mutually different two images created for verifying an uncomfortable feeling in a view through a binocular vision in a monovision prescription state, for each of the right and left eyes.

12. A binocular vision experiencing method, wherein mutually different two images created for verifying an uncomfortable feeling in a view through a binocular vision in a monovision prescription state, are displayed for each of the right and left eyes.

13. The simulation device according to claim 2, wherein the two images generated by the image generation part are an image for a far vision and an image for a near vision.

14. The simulation device according to claim 2, wherein the two images generated by the image generation part are an image for a dominant eye and an image for a non-dominant eye.

15. The simulation device according to claim 2, wherein the image generation part generates an image in which a plurality of image elements having different recognition mode parameters, are shown in a list form.

16. The simulation device according to claim 2, wherein the image generation part is configured to generate the two images in consideration of an angle corresponding to a size of each image element and an angle corresponding to an interval between adjacent image elements.

17. The simulation device according to claim 2, wherein the image generation part is configured to generate the image in consideration of a distance from the examinee to a display image displayed by the image displayer.

18. The simulation device according to claim 2, wherein the image generation part is configured to generate the two images in consideration of a converging angle of the right and left eyes corresponding to the distance from the examinee to the display image displayed by the image displayer.

19. The simulation device according to claim 2, which is used in combination with an ophthalmic aberration measurement device for measuring an aberration of an eyeball of the examinee.
